(19) United States
(12) Patent Application Publication
(10) Pub. No.: US 2022/0342879 A1
(43) Pub. Date: Oct. 27, 2022

(54) DATA SEARCHING SYSTEM, DEVICE, METHOD AND PROGRAM

(71) Applicant: NEC Corporation, Minato-ku, Tokyo (JP)

(72) Inventors: Yuyang Dong, Tokyo (JP); Masafumi Oyamada, Tokyo (JP); Kunihiro Takeoka, Tokyo (JP)

(73) Assignee: NEC Corporation, Minato-ku, Tokyo (JP)

(21) Appl. No.: 17/764,283

(22) PCT Filed: Oct. 8, 2019
(86) PCT No.: PCT/JP2019/039653

§ 371 Date: Mar. 28, 2022

(51) Int. Cl. G06F 16/2455; G06F 16/28

(52) U.S. Cl. CPC G06F 16/2456; G06F 16/285

(57) ABSTRACT

A data index unit 80 manages data of source tables. A data searching unit 90 searches the joinable source tables for the query table. A group indexing unit 81 divides each the source table into a collection of sets, and generates, for each divided set, a group of similar cells included in the set using a similarity function for calculating cell similarity. A data filtering unit 91 searches the source table including a set in which the number of pairs of a first cell included in a divided query table set and a second cell in a group including cells similar to the first cell exceeds a predetermined threshold.

### TECHNICAL FIELD

The present invention relates to a data searching system, data searching device, data searching method and data searching program that searches joinable tables.

### BACKGROUND ART

A “Join” is an important technique to connect two or more tables. Joining two different tables can enrich the data by getting more attributes related to the original data. Data analysis benefits from joining that can process more features and get better performance. For example, the data analyst can join the POS (point of sale) data and the weather data, then learn an extra knowledge: “Rice ball sales well in typhoon day”.

Therefore, for the data analysts who hold their tables, it is a huge need to finding the joinable tables from a large table source. Patent Literature 1 discloses a creating apparatus for searching related tables with an input text. However, the disclosed creating apparatus in Patent Literature 1 receives a query string and outputs the related tables to this string, it cannot be applied into the problem of searching joinable tables for a query table.

Non Patent Literature 1 discloses a method to search joinable tables to an input table. In the method disclosed in Non Patent Literatures 1, the determination of whether two tables are joinable or not is based on the exact join (or equal join) operation. Exact join, as well as the equal join and key-foreign key join, are executed with the values from two different tables that have exactly the same values. FIG. 12 is an exemplary explanatory diagram illustrating an example of tables. For example, in FIG. 12, tables can be joined according to the column of “Store id”.

On the other hand, the data in two tables are not always exactly same. In this case, tables are joined with similarity join (or fuzzy join). Similarity join measures the similarity between two data in a different table. Non Patent Literature 2 discloses a method to find related sets from two tables based on the operation of similarity join on string data.

FIG. 13 is an exemplary explanatory diagram illustrating an example of other tables. For example, in FIG. 13, column “Bestseller” can join another column “Product” in different table according to the similarity between the strings. For example, in FIG. 13, “Google AR Glass” and “Google Glass” are not exactly same, but they have higher similarity on string similarity function such as Jaccard similarity or edit distance. Therefore, Non Patent Literature 2 allows such string fuzzy join and can find related sets on string data efficiently.

Data analysts also require to process a similarity join between two tables on their real number (or numerical vector) data. The similarity functions for measuring two real number data, such as Euclid distance or Cosine similarity, are different from those functions on string data. For example, in FIG. 12, there are coordinates on the column “Location”. After joining two tables, a relation between sales and weather can be figured out. Inputting two tables, Non Patent Literature 3 discloses a method to fast similarity join two tables on the columns of numerical vector data with Euclid distance.

### CITATION LIST

### Patent Literature

### PTL 1

Publication of granted patent No. U.S. Pat. No. 9,607,044 B2

### Non Patent Literature

### NPL 1

Erkang zhu et al., “JOSIE: Overlap Set Similarity Search for Finding Joinable Tables in Data Lakes”, SIGMOD Conference 2019, pp. 847-864, 2019

### NPL 2

Dong Deng et al., “SilkMoth: An Efficient Method for Finding Related Sets with Maximum Matching Constraints”, PVLDB 10(10), pp. 1082-1093, 2017

### NPL 3

You Jung Kim et al., “Performance Comparison of the R*-Tree and the Quadtree for kNN and Distance Join Queries”, IEEE Trans. Knowledge Data Eng., 22(7), pp. 1014-1027, 2010

### SUMMARY OF INVENTION

### Technical Problem

The first problem is to find joinable tables with the real number data similarity join. As the above statement, given a query table, Non Patent Literature 1 can only search the joinable tables which contain the exactly same data to the query table. The method disclosed in Non Patent Literature 1 cannot support similarity join.

Non Patent Literature 2 discloses a method to find joinable tables with similarity join. However, The method disclosed in Non Patent Literature 2 supports the similarity functions on string data, and it cannot support the similarity functions on real number data. In real-world applications, to achieve a good performance in data analysis, many string processing systems tends to transform a string to real number data (numerical vector) with word embedding techniques. Therefore, there is a problem on the above methods that they cannot find joinable tables with the real number data similarity join.

The second problem is to efficiently search for joinable tables from a huge table source. The method disclosed in Non Patent Literature 3 supports the similarity join with real number data, but it is only designed for the case of inputting two tables and retrieve the joinable rows. It is in-efficient or even impossible to use the method disclosed in Non Patent Literature 3 for searching joinable tables. The table source always has a huge number (thousands of, millions of) of tables. To search joinable tables, the method disclosed in Non Patent Literature 3 needs to check the table one by one, which leads an extremely long processing time. Therefore, there is a problem on how to efficiently search for joinable tables from a huge table source.

It is an exemplary object of the present invention to provide a data searching system, data searching device, data searching method and data searching program that can search for joinable tables with similarity join from a large table source within short processing time.

### Solution to Problem

A data searching system for searching joinable source tables for a query table, the searching system according to the present invention includes: a data index unit which manages data of source tables; and a data searching unit which searches the joinable source tables for the query table, wherein, the data index unit includes a group indexing unit which divides each the source table into a collection of sets, and generates, for each divided set, a group of similar cells included in the set using a similarity function for calculating cell similarity, and wherein, the data searching unit includes a data filtering unit which searches the source table including a set in which the number of pairs of a first cell included in a divided query table set and a second cell in a group including cells similar to the first cell exceeds a predetermined threshold.

A data searching device for searching joinable source tables for a query table, the searching device according to the present invention includes: an input unit which inputs a group of similar cells generated for each column of each source table using a similarity function for calculating cell similarity; and a data filtering unit which searches the source table including a set in which the number of pairs of a first cell included in a divided query table set and a second cell in a group including cells similar to the first cell exceeds a predetermined threshold.

A data searching method for searching joinable source tables for a query table, the searching method according to the present invention includes: dividing each the source table into a collection of sets, and generating, for each divided set, a group of similar cells included in the set using a similarity function for calculating cell similarity, and searching the source table including a set in which the number of pairs of a first cell included in a divided query table set and a second cell in a group including cells similar to the first cell exceeds a predetermined threshold.

Another data searching method for searching joinable source tables for a query table, the searching method according to the present invention includes: inputting a group of similar cells generated for each column of each source table using a similarity function for calculating cell similarity; and searching the source table including a set in which the number of pairs of a first cell included in a divided query table set and a second cell in a group including cells similar to the first cell exceeds a predetermined threshold.

A data searching program for searching joinable source tables for a query table, the data searching program according to the present invention causes a computer to perform: an input process of inputting a group of similar cells generated for each column of each source table using a similarity function for calculating cell similarity; and a data filter process of searching the source table including a set in which the number of pairs of a first cell included in a divided query table set and a second cell in a group including cells similar to the first cell exceeds a predetermined threshold.

### Advantageous Effects of Invention

According to the present invention, it is possible to search for joinable tables with similarity join from a large table source within short processing time.

### BRIEF DESCRIPTION OF DRAWINGS

FIG. 1 It depicts an exemplary block diagram illustrating the structure of an exemplary embodiment of the data index unit according to the present invention.

FIG. 2 It depicts a flowchart illustrating an example of data index processing by the data index unit according to Exemplary Embodiment 1.

FIG. 3 It depicts an explanatory diagram illustrating an example of processing for creating a group.

FIG. 4 It depicts an explanatory diagram illustrating an example of the dominating relationship.

FIG. 5 It depicts an exemplary block diagram illustrating the structure of an exemplary embodiment of the data searching system according to the present invention.

FIG. 6 It depicts a flowchart illustrating an example of data searching processing by the data searching unit according to Exemplary Embodiment 2.

FIG. 7 It depicts an explanatory diagram illustrating an example of processing for calculating the lower bound of the matched pairwise cells.

FIG. 8 It depicts an exemplary block diagram illustrating the structure of an exemplary embodiment of the data visualization system according to the present invention.

FIG. 9 It depicts a flowchart illustrating an example of data visualization processing by the graph creating unit according to Exemplary Embodiment 3.

FIG. 10 It depicts a block diagram illustrating an outline of the data searching system according to the present invention.

FIG. 11 It depicts a block diagram illustrating an outline of the data searching device according to the present invention.

FIG. 12 It depicts an exemplary explanatory diagram illustrating an example of tables.

FIG. 13 It depicts an exemplary explanatory diagram illustrating an example of other tables.

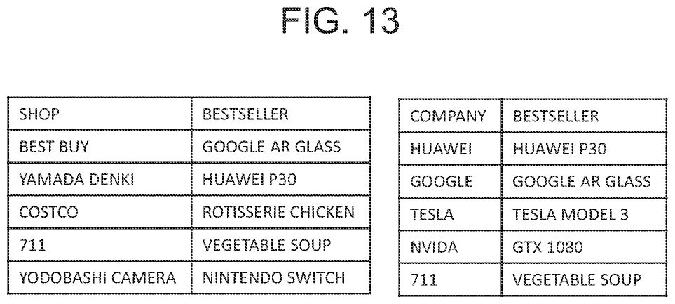

### DESCRIPTION OF EMBODIMENTS

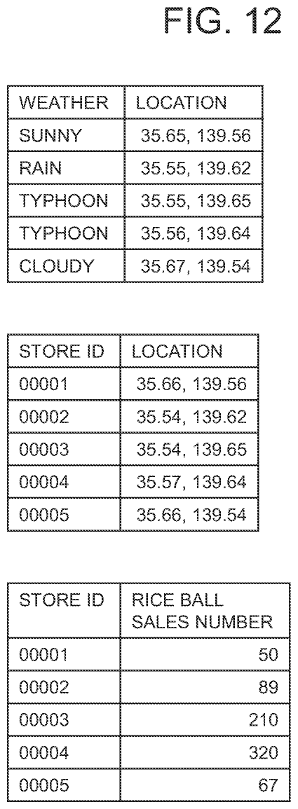

First, terms used in this embodiment will be described. For a pair of columns from a different table, if enough of the cell values in the columns are matched, it makes sense to join them. In the following description, a single data in a table column is called a “cell”. For example, the “SUNNY” in FIG. 12 is a cell of Column “WEATHER”. The column is called a “set”.

If the two cells have a large similarity value than a given cell similarity threshold T_{cell} according to a cell similarity function f, it is called “match”, and denoted as the following Equation 1.

[Math. 1]

Match(q,x): {ƒ(q,x)≥2_{cell}} (Equation 1)

In the Equation 1, the f(q,x) is the cell similarity function between cell q and cell x. |Match(q,x)| is the number of the pairs that the similarity is large than the cell similarity threshold T_{cell}. A set similarity function F is calculated according to the number with a specific function u. The set similarity function F is denoted as the following Equation 2.

[Math. 2]

F(A,B)=u(|Match(a,b)|),a∈A,b∈B (Equation 2)

Two sets are defined as joinable when the value of function F exceeds a set similarity threshold Tₛₑₜ, and denoted as the following Equation 3.

[Math. 3]

J(A,B):{F(A,B)≥Tₛₑₜ} (Equation 3)

The searching joinable table problem are formally defined as two versions. The one is a query version, and the other is an all pair version.

Regarding the query version, given a collection of sets X, a query set Q, as well as the set similarity threshold Tₛₑₜ and the cell similarity threshold T_{cell}, and then we find the sets A that

[Math. 4]

{A:J(A,Q),A∈S,S≳X}

Regarding the all pair version, given a collection of sets X, the set similarity threshold Tₛₑₜ and the cell similarity threshold T_{cell}, and then for each set xᵢ that is an element of X, we find the sets A that

[Math. 5]

{A:J(A,xᵢ),A∈S,S≳X}

Hereinafter, example embodiments of the present invention will be described with reference to the accompanying drawings. In all the drawings, like elements are referenced by like reference numerals and the descriptions thereof will not be repeated.

### Exemplary Embodiment 1

A data index unit will be described as a first exemplary embodiment of the present invention. The data index unit of the first exemplary embodiment indexes and manages table data. That is, a plurality of tables is indexed and managed in the data index unit. The data index unit supports to insert, delete and update a single table. In the following, the details of inserting a table are mainly introduced since the deletion has a similar (reverse) processing flow to cope with the same unit, and the update operation is a combination of an insertion and deletion.

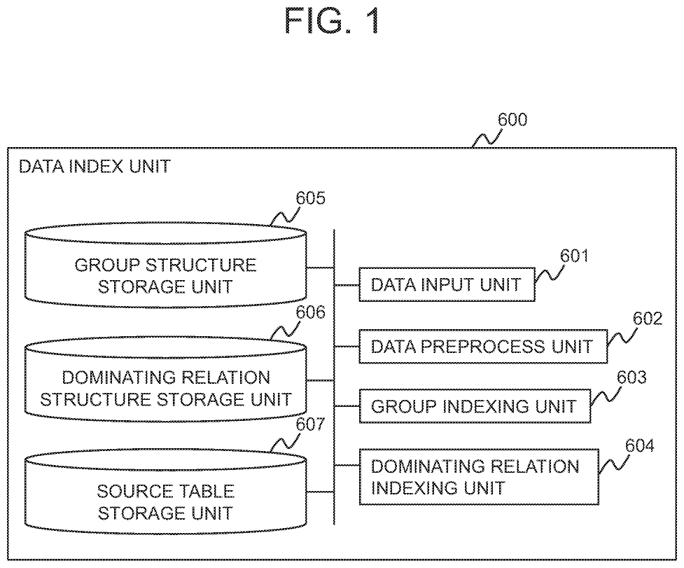

FIG. 1 depicts an exemplary block diagram illustrating the structure of an exemplary embodiment of the data index unit according to the present invention. A data index unit 600 according to the present exemplary embodiment includes a data input unit 601, a data preprocess unit 602, a group indexing unit 603, a dominating relation indexing unit 604, a group structure storage unit 605, a dominating relation structure storage unit 606 and a source table storage unit 607.

The data input unit 601 acquires a plurality of tables. The data preprocess unit 602 preprocesses the input tables to make the tables able to index. The group indexing unit 603 partitions similar the cells a table into groups and indexes the group structures into group structure storage unit 605. The dominating relation indexing unit 604 extracts the dominating relations between groups and indexes these relations into the dominating relation structure storage unit 606. The source table storage unit 607 stores the original input tables.

The data input unit 601, the data preprocess unit 602, the group indexing unit 603 and the dominating relation indexing unit 604 are implemented by a CPU of a computer operating according to a program (data index program). For example, the program may be stored in the storage unit (not shown) included in the data index unit 600, with the CPU reading the program and, according to the program, operating as the data input unit 601, the data preprocess unit 602, the group indexing unit 603 and the dominating relation indexing unit 604. The functions of the data index unit may be provided in the form of SaaS (Software as a Service).

The data input unit 601, the data preprocess unit 602, the group indexing unit 603 and the dominating relation indexing unit 604 may each be implemented by dedicated hardware. All or part of the components of each device may be implemented by general-purpose or dedicated circuitry, processors, or combinations thereof. They may be configured with a single chip, or configured with a plurality of chips connected via a bus. All or part of the components of each device may be implemented by a combination of the above-mentioned circuitry or the like and program.

In the case where all or part of the components of each device is implemented by a plurality of information processing devices, circuitry, or the like, the plurality of information processing devices, circuitry, or the like may be centralized or distributed. For example, the information processing devices, circuitry, or the like may be implemented in a form in which they are connected via a communication network, such as a client-and-server system or a cloud computing system.

Moreover, the group structure storage unit 605, the dominating relation structure storage unit 606 and the source table storage unit 607 are realized by, for example, a magnetic disk or the like. The contents of each unit will be specifically described below.

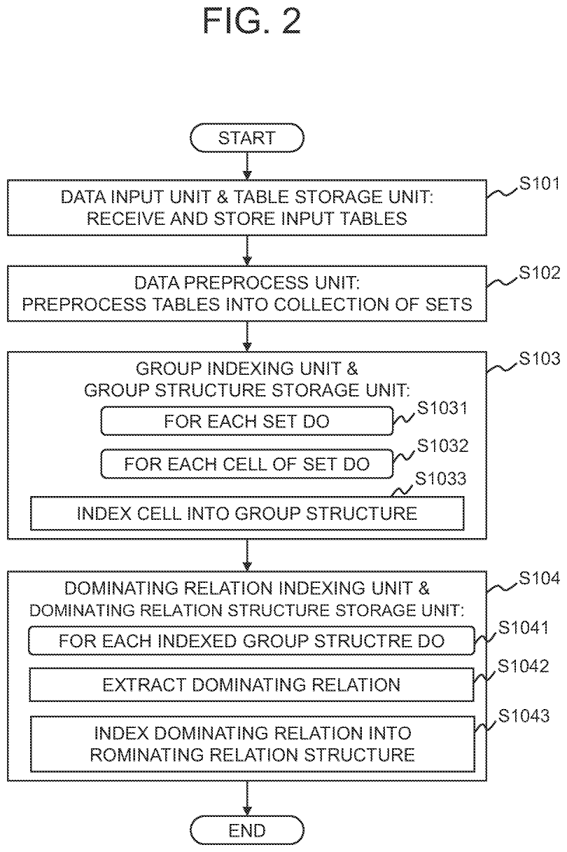

FIG. 2 depicts a flowchart illustrating an example of data index processing by the data index unit 600 according to the present exemplary embodiment. In step S101, the data input unit 601 acquires a plurality of source tables, and stores these tables in the source table storage unit 607. In step S102, the data preprocess unit 602 receives the input tables from step S101. Firstly, the data preprocess unit 602 divides each table into a collection of sets. A column of a table is extracted as a set. Secondly, the data preprocess unit 602 transforms the sets which contains string data to real number data. Note that a method of transforming string data into real number data is widely known, and detailed description thereof is omitted here. Finally, the data preprocess unit 602 cleans the dirty data and normalizes the data to be ready for the future processing in step S103.

In step S103, the group indexing unit 603 receives the preprocessed sets from step S102. The group indexing unit 603 creates a group structure which contains a collection of groups for each set in step S103. Groups of a group structure are created according to the cells in the set and the similarity function f. That is, the group indexing unit 603 generates, for each divided set, a group of similar cells included in the set using the similarity function f.

Specifically, the process of the following step S1033 is performed for each set and each cell of the set (steps S1031 and S1032). In step S1033, the group indexing unit 603 creates some groups named “small group” according to the value of cell similarity threshold T_{cell} and the cell similarity function f. Cells in a same small group has a higher similarity value than T_{cell}, so all cells must “match” with each other with the cell similarity function f.

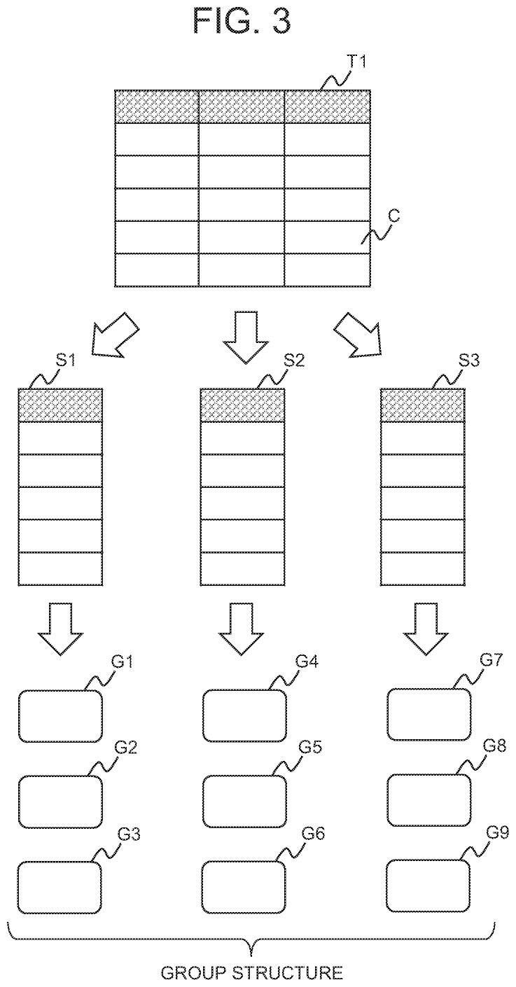

FIG. 3 depicts an explanatory diagram illustrating an example of processing for creating a group. As illustrated in FIG. 3, the table T1 is divided into sets (columns) S1 to S3, and the cells C included in each set are grouped (groups G1 to G9) using the cell similarity function f. In the example shown in FIG. 3, the number of groups in each set is the same, but in other cases the number of groups may be different.

In step S1033, the group indexing unit 603 also creates “large group” to index cells. The large group is created corresponding to the small group. Specifically, the group indexing unit 603 creates the large group having the same center as the small group and having a wider range than the small group. The range of the large group may cover all cells whose similarity to the center is less than 1.5 times of T_{cell}. Therefore, for all cells in the small group, they may match the cells in the large group, but must not match the cells out of the large group.

For each set from step S102, the group indexing unit 603 creates a collection of small groups and a collection of large groups, and indexes these groups into a group structure. The group structure represents a set and is indexed into the group structure storage unit 605.

After creating the group structures for all sets, in step S104, the dominating relation indexing unit 604 extracts the dominating relations between groups and indexes them into the dominating relation structure storage unit 606. The dominating relationship is a relationship defined based on the size relationship of the number of cells included in each set group, and indicates a relationship in which a set including a group having a large number of cells dominates a set including the same group having a small number of cells. Hereinafter, the processing by the dominating relation indexing unit 604 will be specifically described.

For each indexed group structure (step S1041), the dominating relation indexing unit 604 extracts the dominating relations between this group structure and others group structures in step S1042. The definition of dominating relation between two group structures is as follows.

[Math. 6]

Dom_{L}(A,B):{H∥G_{A}.hᵢ|≤|G_{B}.hᵢ|,hᵢ∈H}

Dom_{S}(A,B):{H∥G_{A}.hᵢ|≥|G_{B}.hᵢ|,hᵢ∈H}

Dom_{E}(A,B):{H|G_{A}=∅,G_{B}=∅,hᵢ∈H}

|G_{A}.hᵢ| is the cells number of group hᵢ in the group structure G_{A}. Dom_{L} (A,B) is the collections of small groups which has less cells in set A than that in set B. Dom_{S} (A,B) is the collections of large groups which has more cells in set A than that in set B. Dom_{E} (A,B) is the collections of large groups which are empty in both set A and set B.

In step S1043, the dominating relation indexing unit 604 indexes the dominating relations for a group structure with a tree structure or inverted index structure and stores the dominating relations into the dominating relation structure storage unit 606.

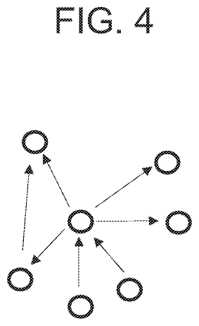

FIG. 4 depicts an explanatory diagram illustrating an example of the dominating relationship. The example illustrated in FIG. 4 expresses the dominating relationship with a directed graph. Specifically, a circle illustrated in FIG. 4 indicates a candidate set, and an arrow indicates a dominating relationship.

Specifically, the dominating relation indexing unit 604 stores the dominating relations Dom_{L} (A,B) with small groups as small group dominating relations in the dominating relation structure storage unit 606. The dominating relation indexing unit 604 also stores the dominating relations Dom_{S} (A,B) with large groups as large group dominating relations in the dominating relation structure storage unit 606. Moreover, the dominating relation indexing unit 604 stores the dominating relations Dom_{E} (A,B) with large groups as empty group dominating relations in the dominating relation structure storage unit 606.

As described above, according to the present exemplary embodiment, the group indexing unit 603 partitions every column of the table into groups using the similarity function, and indexes the similar cells in a column in a same group. Furthermore, the dominating relation indexing unit 604 extracts the dominating relationship between groups from different columns and indexes the dominating relationship. Therefore, a huge number of tables can be indexed and managed. Note that the indexed tables are maintained with operations of insertion, deletion and update in the data index unit 600.

### Exemplary Embodiment 2

Next, a second exemplary embodiment of the present invention will be described. A data searching system will be described as a second exemplary embodiment of the present invention. The data searching system is a system for finding joinable tables.

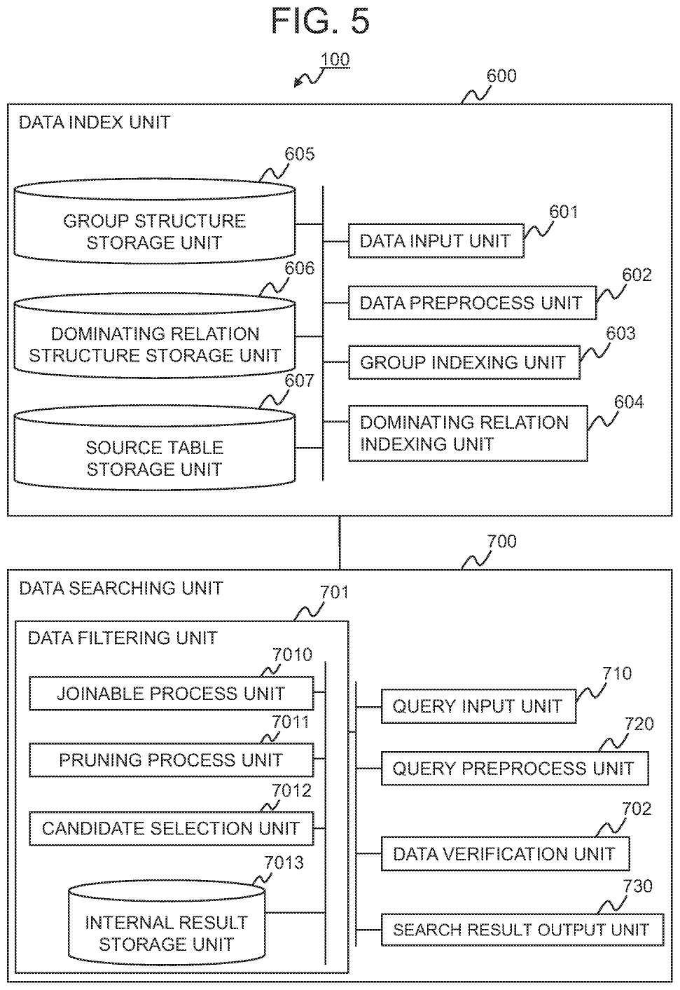

FIG. 5 depicts an exemplary block diagram illustrating the structure of an exemplary embodiment of the data searching system according to the present invention. The data searching system 100 according to the present exemplary embodiment includes the data index unit 600 and a data searching unit 700. The data index unit 600 is same as the first exemplary embodiment.

The data searching unit 700 utilizes the indexed group structures and dominating relations to efficient search joinable tables for an input query table. Note that the single data searching unit 700 of the present exemplary embodiment may be realized as the data searching system 100. For example, when the group structure and the dominating relation have already been created, the data searching unit 700 as the data searching system 100 may acquire these pieces of information from an external storage unit (not shown) and perform the processing described later. In this case, the data searching unit 700 can be called a data searching device.

The data searching unit 700 according to the present exemplary embodiment includes a query input unit 710, a query preprocess unit 720, a data filtering unit 701, a data verification unit 702 and a search result output unit 730.

The data filtering unit 701 includes a joinable process unit 7010, a pruning process unit 7011, a candidate selection unit 7012 and a internal result storage unit 7013.

The query input unit 710 acquires the input query table and set the similarity threshold Tₛₑₜ. The query input unit 710 may input a group of similar cells stored in the group structure storage unit 605. The query preprocess unit 720 preprocesses the input query table into sets. The data filtering unit 701 filters tables that are apparently joinable or not joinable. The data verification unit 702 verifies tables which cannot be filtered by the data filtering unit 701. The search result output unit 730 returns the searched joinable tables.

The joinable process unit 7010 defines that two sets are joinable or nor joinable. The pruning process unit 7011 prunes the candidate tables. The candidate selection unit 7012 selects a proper next candidate to process. The internal result storage unit 7013 stores the internal results during filter process described later.

The query input unit 710, the query preprocess unit 720, the data filtering unit 701 (more specifically, the joinable process unit 7010, the pruning process unit 7011 and the candidate selection unit 7012), the data verification unit 702 and the search result output unit 730 are implemented by a CPU of a computer operating according to a program (data searching program). The query input unit 710, the query preprocess unit 720, the data filtering unit 701 (more specifically, the joinable process unit 7010, the pruning process unit 7011 and the candidate selection unit 7012), the data verification unit 702 and the search result output unit 730 may each be implemented by dedicated hardware.

Moreover, the internal result storage unit 7013 is realized by, for example, a magnetic disk or the like.

The contents of each unit will be specifically described below.

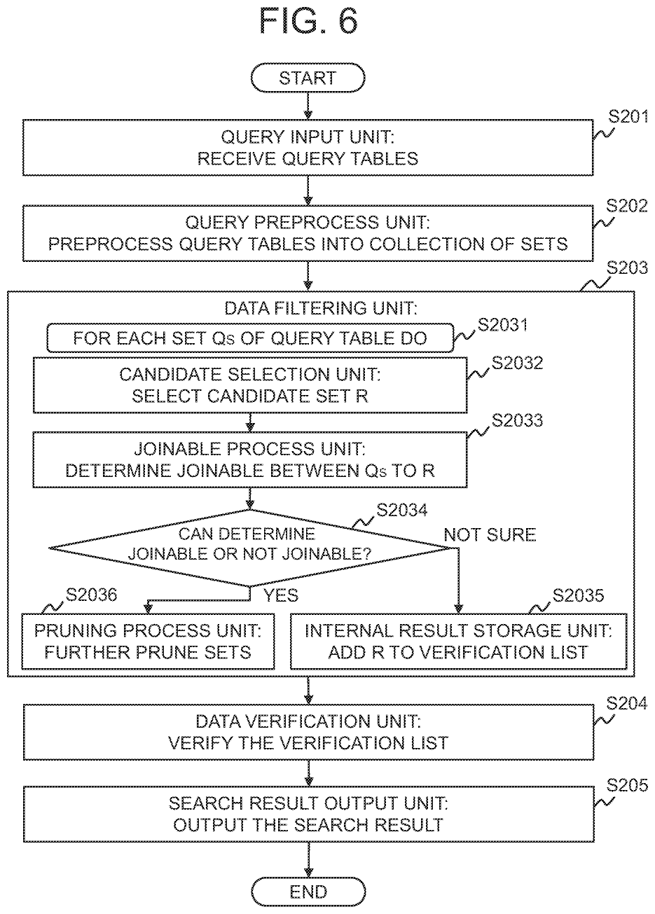

FIG. 6 depicts a flowchart illustrating an example of data searching processing by the data searching unit 700. In step S201, the query input unit 710 acquires a query table. In step S202, the query preprocess unit 720 receives the input tables from step S201. Firstly, the query preprocess unit 720 divides each table into a collection of sets. A column of a table is extracted as a set. Secondly, the query preprocess unit 720 transforms the sets which contains string data to real number data. The transformation method using the query preprocess unit 720 is the same as the transformation method using the data preprocess unit 602 of the first exemplary embodiment. Finally, the query preprocess unit 720 cleans the dirty data and normalizes the data to be ready for the future processing in step S203.

For each set of the input query table (Step S2031), in Step S2032, the candidate selection unit 7012 selects a candidate indexed set with a group structure from the group structure storage unit 605 by a greedy method on the cost function of maximum number of dominating relations according to the dominating relation structure storage unit 606. That is, the candidate selection unit 7012 preferentially selects, as search candidates, a set that has more sets that are dominated by the dominating relationship.

In step S2033, the joinable process unit 7010 determines if the selected set R is joinable to the query set Q. Specifically, the joinable process unit 7010 determines the joinability by checking if the value of the set similarity function F exceeds the set similarity threshold Tₛₑₜ.

The joinable process unit 7010 may calculate a lower bound of the number of matched cells according to the group structure G_{R}. Specifically, for each cell q (hereinafter, it may be described as a first cell) which is an element of set Qₛ of the query table, the joinable process unit 7010 tries q to be mapped to a corresponding group in G_{X}, which means to find if there exists a group in G_{R} that can cover q.

If q can be mapped to a group g which is an element of G_{R}, the number of cells in g (hereinafter, it may be described as a second cell) is a lower bound of the matching numbers between cell q and set Q. Therefore, the joinable process unit 7010 may calculate the lower bound of the matched pairwise cells between Q_{S} and R by summing up the lower bound values of all cell s which is an element of Q_{S}.

As described above, the joinable process unit 7010 searches a source table including a set in which the number of pairs (that is, the lower bound) of a first cell included in a divided query table column and a second cell in a group including cells similar to the first cell exceeds a predetermined threshold (that is the set similarity threshold Tₛₑₜ). Thereby, processing time can be shortened compared with the case where cells are compared one by one.

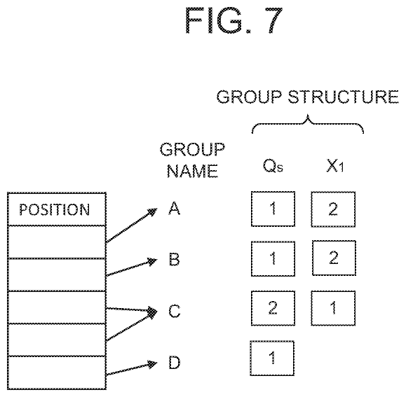

FIG. 7 depicts an explanatory diagram illustrating an example of processing for calculating the lower bound of the matched pairwise cells. In the example illustrated in FIG. 7, it is assumed that the set Qₛ is a set indicating a position. First, the joinable process unit 7010 associates the cells of the set Qₛ with the group corresponding to X₁ (that is, the cell similarity is equal to or less than the set similarity threshold Tₛₑₜ). In the example illustrated in FIG. 7, it is assumed that one cell is assigned to group A, one cell is assigned to group B, two cells are assigned to group C, and one cell is assigned to group D, respectively.

Next, the joinable process unit 7010 calculates the lower bound of the matched pairwise cells between Q_{S} and X1. In X1, it is assumed that two cells are classified into group A, two cells are classified into group B, and one cell is classified into group C. At this time, the joinable process unit 7010 calculates the lower bound of the matched paiwise cells as 1*2+1*2+2*1=6.

The joinable process unit 7010 may calculate an upper bound of the number of matched cells according to the group structure G_{R}. Specifically, during mapping a cell q to a corresponding group in G_{R}, q may also match the cells in near groups to the mapped group. Therefore, the cells number in these near groups can form an upper bound. Then, the joinable process unit 7010 may calculate the upper bound of the matched pairwise cells between Q_{S} and R by summing up the upper bound values of all cells s which is an element of Q_{S}.

In step S2033, during calculating the upper bound of Q_{S} and R on the joinable process unit 7010, if a cell of q which is element of Q_{S} cannot be mapped to the corresponding any group in G_{R}, that means q cannot match any cells in R. The joinable process unit 7010 may counts the number of this kind of unmatched cells. The number can be used to determine that Q_{S} and R are not joinable according to the set similarity function F.

In Step S2034, the joinable process unit 7010 may determine Q_{S} and R as joinable by checking lower bound of matching numbers with Tₛₑₜ. The joinable process unit 7010 may determine Q_{S} and R as not joinable by checking the upper bound with Tₛₑₜ, or by checking the number of unmatched cells with Tₛₑₜ. For example, it is assumed that Tₛₑₜ is set to 5 in the process illustrated in FIG. 7. In this case, the lower bound is above Tₛₑₜ. Therefore, the joinable process unit 7010 may determine Q_{S} and X₁ as joinable.

For the case that Q_{S} and R cannot be determined as joinable or not joinable in S2034 (not sure in S2024), the joinable process unit 7010 may add them into the verification list stored in the internal result storage unit 7013 for the future verification process by the data verification unit 702.

On the other hand, for the case that Q_{S} and R can be determined as joinable or not joinable in S2034 (YES in S2024), that is, when the current set R is determined as joinable or not joinable, the pruning process unit 7011 further prunes the other candidate sets according to the dominating relations storage in the dominating relation structure storage unit 606.

Specifically, if R is determined as joinable, the pruning process unit 7011 retrieves the large dominating relation of R from the dominating relation structure storage unit 606. The pruning process unit 7011 determines all sets in this large dominating relation as joinable and pruned. If R is determined as not joinable, the pruning process unit 7011 retrieves the small dominating relation of R from the dominating relation structure storage unit 606. The pruning process unit 7011 determines all sets in this small dominating relation as not joinable and pruned.

Moreover, in Step S2036, when Q_{S} and R are defined as not joinable by unmatched cells, the pruning process unit 7011 retrieves the empty dominating relation of R from the dominating relation structure storage unit 606. The pruning process unit 7011 determines all sets in this empty dominating relation as not joinable and pruned.

In this way, the pruning process unit 7011 extracts columns that are dominated by the dominating relationship, and the joinable process unit 7010 excludes the extracted columns from the search candidates. Therefore, the overall search can be speeded up.

In step S204, the data verification unit 702 verifies the verification list in the internal result storage unit 7013. The data verification unit 702 may verify the source tables using the lower bound or upper bound (number of the pairs). For example, the data verification unit 702 may extract a set whose lower bound is close to a threshold value (within a predetermined range) from the verification list as a candidate, and verify whether the candidate is joinable or not joinable. The verification method is arbitrary. This makes it possible to select more sets that are joinable.

In step S205, the search result output unit 730 summaries the results of joinable tables in step S203 and step S204, and outputs them.

As described above, according to the present exemplary embodiment, the query input unit 710 inputs a group of similar cells generated for each column of each source table using a similarity function f, and a data filtering unit 701 (the joinable process unit 7010) searches a source table including a set in which the number of pairs exceeds a predetermined threshold (the set similarity threshold Tₛₑₜ). Therefore, it is possible to search for joinable tables with similarity join on the real number data from a large table source within short processing time.

### Exemplary Embodiment 3

Next, a third exemplary embodiment of the present invention will be described. A data visualization system will be described as a third exemplary embodiment of the present invention. The data visualization system is a system for visualizing (e.g. displaying) a join graph. The join graph is a graph structure to represent a joinable relationship between multiple tables. In the join graph, a node represents a table, and an edge between two tables represents that they are joinable. The join graph represents the connections in multiple tables, and it is used in many data analyzing methods.

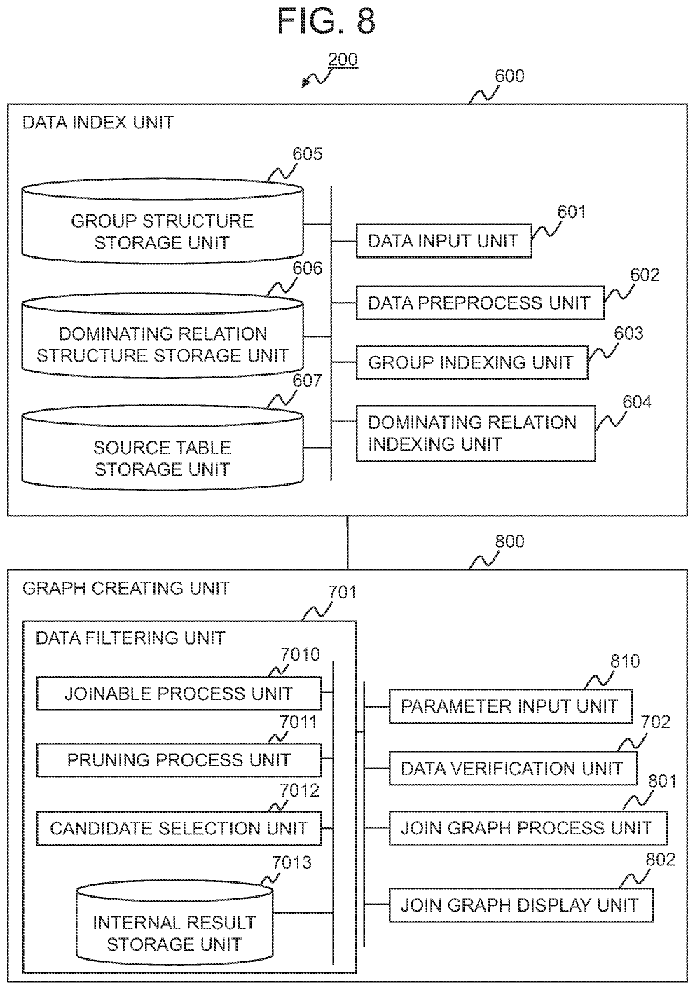

FIG. 8 depicts an exemplary block diagram illustrating the structure of an exemplary embodiment of the data visualization system according to the present invention. The data visualization system 200 according to the present exemplary embodiment includes the data index unit 600 and a graph creating unit 800. The data index unit 600 is same as the first exemplary embodiment.

Note that the single graph creating unit 800 of the present exemplary embodiment may be realized as the data visualization system 200. For example, when the group structure and the dominating relation have already been created, the graph creating unit 800 as the data visualization system 200 may acquire these pieces of information from an external storage unit (not shown) and perform the processing described later. In this case, the graph creating unit 800 can be called a graph creating device.

The single graph creating unit 800 according to the present exemplary embodiment includes a parameter input unit 810, the data filtering unit 701, the data verification unit 702, a join graph process unit 801 and a join graph display unit 802. The data filtering unit 701 and the data verification unit 702 are same as the second exemplary embodiment.

The join graph process unit 801 creates a join graph on some or all tables in the data visualization system 200. The join graph display unit 802 displays the join graph.

The parameter input unit 810, the data filtering unit 701 (more specifically, the joinable process unit 7010, the pruning process unit 7011 and the candidate selection unit 7012), the data verification unit 702, the join graph process unit 801 and the join graph display unit 802 are implemented by a CPU of a computer operating according to a program (data searching program).

The contents of each unit will be specifically described below.

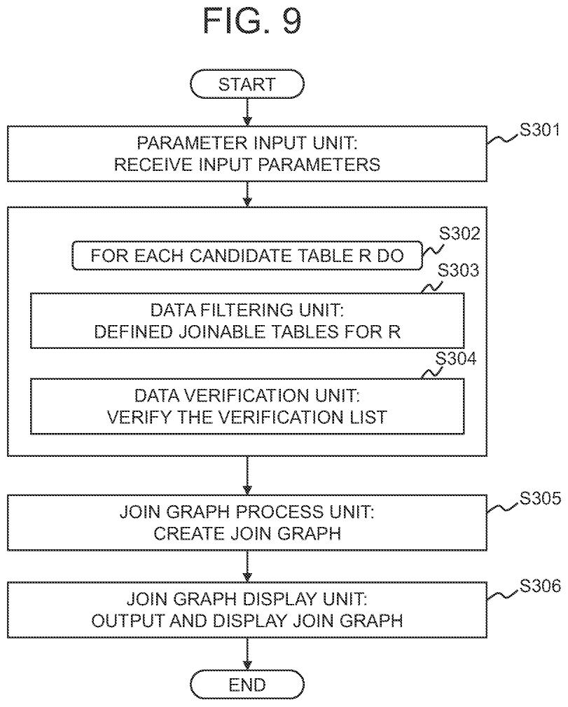

FIG. 9 depicts a flowchart illustrating an example of data visualization processing by the graph creating unit 800. In step S301, the parameter input unit 810 acquires the set similarity threshold Tₛₑₜ and the conditions of visualization a join graph.

For each indexed table R (step S302), the data filtering unit 701 and data verification unit 702 search the joinable tables for R (step S303, step S304). In step S305, the join graph process unit 801 creates the join graph according to the information of joinable tables of some or all indexed tables. In step S306, the join graph display unit 802 outputs the join graph and displays the join graph.

As described above, according to the present exemplary embodiment, the graph creating unit 800 visualizes a join graph representing a joinable relationship between multiple tables using the group using the groups generated by the data index unit 600. Therefore, it is possible to create a table join graph efficiently and display the join graph with the user's request.

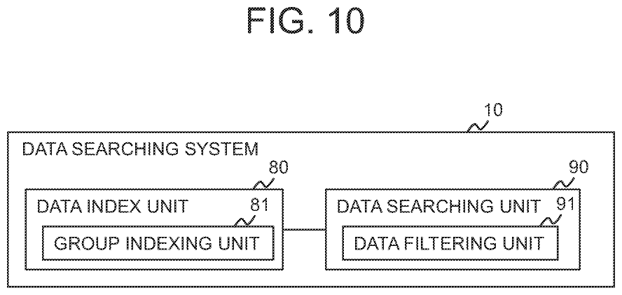

Next, an outline of the present invention will be described. FIG. 10 depicts a block diagram illustrating an outline of the data searching system according to the present invention. The data searching system 10 (for example, the data searching system 100) for searching joinable source tables for a query table, the searching system includes: a data index unit 80 (for example, the data index unit 600) which manages data of source tables; and a data searching unit 90 (for example, the data searching unit 700) which searches the joinable source tables for the query table.

The data index unit 80 includes a group indexing unit 81 (for example, the group indexing unit 603) which divides each the source table into a collection of sets, and generates, for each divided set, a group of similar cells included in the set using a similarity function (for example, the similarity function f) for calculating cell similarity.

The data searching unit 90 includes a data filtering unit 91 (for example, the data filtering unit 701, joinable process unit 7010) which searches the source table including a set in which the number of pairs (for example, the lower bound) of a first cell included in a divided query table set and a second cell in a group including cells similar to the first cell exceeds a predetermined threshold (for example, the set similarity threshold Tₛₑₜ).

With such a configuration, it is possible to search for joinable tables with similarity join from a large table source within short processing time.

Further, the data index unit 80 may further include a dominating relation extracting unit (for example, the dominating relation indexing unit 604) which extracts a dominating relationship that is a relationship defined based on the size relationship of the number of cells included in each set group, and that indicates a relationship in which a set including a group having a large number of cells dominates a set including the same group having a small number of cells, and the data filtering unit 91 may preferentially select, as search candidates, a set that has more sets that are dominated by the dominating relationship.

Specifically, the data searching unit 90 may further include a pruning process unit (for example, the pruning process unit 7011) which extracts sets that are dominated by the dominating relationship, and the data filtering unit 91 may excludes the extracted sets from the search candidates.

Further, the data searching system 10 may further include a visualization unit (for example, the graph creating unit 800) which visualizes a join graph representing a joinable relationship between multiple tables.

Further, the data searching unit 90 may further include a data verification unit (for example, the data verification unit 702) which verifies the source tables using number of the pairs of the first cell and the second cell.

Further, the data index unit 80 may further include a data preprocess unit (for example, the data preprocess unit 602) which transforms the sets which contains string data to real number data.

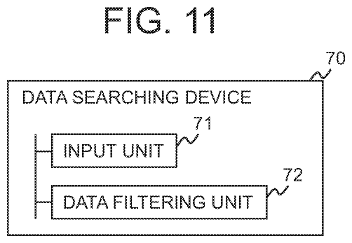

FIG. 11 depicts a block diagram illustrating an outline of the data searching device according to the present invention. The data searching device 70 (for example, the data searching unit 700) for searching joinable source tables for a query table, the searching device includes: an input unit 71 (for example, the query input unit 710) which inputs a group of similar cells generated for each column of each source table using a similarity function for calculating cell similarity; and a data filtering unit 72 (for example, the data filtering unit 701, joinable process unit 7010) which searches the source table including a set in which the number of pairs (for example, the lower bound) of a first cell included in a divided query table set and a second cell in a group including cells similar to the first cell exceeds a predetermined threshold (for example, the set similarity threshold Tₛₑₜ).

With such a configuration, it is also possible to search for joinable tables with similarity join from a large table source within short processing time.

Note that, a part of or all of the above exemplary embodiments can also be described as following supplementary notes, but is not limited to the following.

(Supplementary Note 1)
A data searching system for searching joinable source tables for a query table, the searching system comprising:
a data index unit which manages data of source tables; and
a data searching unit which searches the joinable source tables for the query table,
wherein, the data index unit includes a group indexing unit which divides each the source table into a collection of sets, and generates, for each divided set, a group of similar cells included in the set using a similarity function for calculating cell similarity, and
wherein, the data searching unit includes a data filtering unit which searches the source table including a set in which the number of pairs of a first cell included in a divided query table set and a second cell in a group including cells similar to the first cell exceeds a predetermined threshold.

(Supplementary Note 2)
The data searching system according to Supplementary note 1,
wherein, the data index unit further includes a dominating relation extracting unit which extracts a dominating relationship that is a relationship defined based on the size relationship of the number of cells included in each set group, and that indicates a relationship in which a set including a group having a large number of cells dominates a set including the same group having a small number of cells, and
wherein, the data filtering unit preferentially selects, as search candidates, a set that has more sets that are dominated by the dominating relationship.

(Supplementary Note 3)
The data searching system according to Supplementary note 2,
wherein, the data searching unit further includes a pruning process unit which extracts sets that are dominated by the dominating relationship, and
wherein, the data filtering unit excludes the extracted sets from the search candidates.

(Supplementary Note 4)
The data searching system according to any one of Supplementary notes 1 to 3, further comprising a visualization unit which visualizes a join graph representing a joinable relationship between multiple tables.

(Supplementary Note 5)
The data searching system according to any one of Supplementary notes 1 to 4,
wherein, the data searching unit further includes a data verification unit which verifies the source tables using number of the pairs of the first cell and the second cell.

(Supplementary Note 6)
The data searching system according to any one of Supplementary notes 1 to 5,
wherein, the data index unit further includes a data preprocess unit which transforms the sets which contains string data to real number data.

(Supplementary Note 7)
A data searching device for searching joinable source tables for a query table, the searching device comprising:
an input unit which inputs a group of similar cells generated for each column of each source table using a similarity function for calculating cell similarity; and
a data filtering unit which searches the source table including a set in which the number of pairs of a first cell included in a divided query table set and a second cell in a group including cells similar to the first cell exceeds a predetermined threshold.

(Supplementary Note 8)
A data searching method for searching joinable source tables for a query table, the searching method comprising:
dividing each the source table into a collection of sets, and generating, for each divided set, a group of similar cells included in the set using a similarity function for calculating cell similarity, and
searching the source table including a set in which the number of pairs of a first cell included in a divided query table set and a second cell in a group including cells similar to the first cell exceeds a predetermined threshold.

(Supplementary Note 9)
The data searching method according to Supplementary note 8, further comprising:
extracting a dominating relationship that is a relationship defined based on the size relationship of the number of cells included in each set group, and that indicates a relationship in which a set including a group having a large number of cells dominates a set including the same group having a small number of cells, and
selecting preferentially, as search candidates, a set that has more sets that are dominated by the dominating relationship.

(Supplementary Note 10)
A data searching method for searching joinable source tables for a query table, the searching method comprising:
inputting a group of similar cells generated for each column of each source table using a similarity function for calculating cell similarity; and
searching the source table including a set in which the number of pairs of a first cell included in a divided query table set and a second cell in a group including cells similar to the first cell exceeds a predetermined threshold.

(Supplementary Note 11)
A data searching program for searching joinable source tables for a query table, the data searching program causes a computer to perform:
an input process of inputting a group of similar cells generated for each column of each source table using a similarity function for calculating cell similarity; and
a data filter process of searching the source table including a set in which the number of pairs of a first cell included in a divided query table set and a second cell in a group including cells similar to the first cell exceeds a predetermined threshold.

### REFERENCE SIGNS LIST

100 data searching system
200 data visualization system
600 data index unit
601 data input unit
602 data preprocess unit
603 group indexing unit
604 dominating relation indexing unit
605 group structure storage unit
606 dominating relation structure storage unit
607 source table storage unit
700 data searching unit
701 data filtering unit
7010 joinable process unit
7011 pruning process unit
7012 candidate selection unit
7013 internal result storage unit
702 data verification unit
710 query input unit
720 query preprocess unit
730 search result output unit
800 graph creating unit
801 join graph process unit
802 join graph display unit
810 parameter input unit

What is claimed is:

1. A data searching system for searching joinable source tables for a query table, the data searching system comprising:
one or more memories storing instructions; and
one or more processors configured to execute the instructions to:
divide each the source table into a collection of sets, and generate, for each divided set, a group of similar cells included in the set using a similarity function for calculating cell similarity; and
search the source table including a set in which the number of pairs of a first cell included in a divided query table set and a second cell in a group including cells similar to the first cell exceeds a predetermined threshold.

2. The data searching system according to claim 1, wherein the processor further executes instructions to:
extract a dominating relationship that is a relationship defined based on a size relationship of the number of cells included in each set group, and that indicates a relationship in which a set including a group having a large number of cells dominates a set including a same group having a small number of cells; and
select, as search candidates, a set that has more sets that are dominated by the dominating relationship.

3. The data searching system according to claim 2,
wherein, the processor further executes instructions to:
extract sets that are dominated by the dominating relationship; and
exclude the extracted sets from the search candidates.

4. The data searching system according to claim 1, wherein the processor further executes instructions to visualize a join graph representing a joinable relationship between multiple tables.

5. The data searching system according to claim 1, wherein the processor further executes instructions to
verify the source tables using number of the pairs of the first cell and the second cell.

6. The data searching system according to claim 1, wherein the processor further executes instructions to
transform the sets which contains string data to real number data.

7. A data searching device for searching joinable source tables for a query table, the data searching device comprising:
one or more memories storing instructions; and
one or more processors configured to execute the instructions to:
input a group of similar cells generated for each column of each source table using a similarity function for calculating cell similarity; and
search the source table including a set in which the number of pairs of a first cell included in a divided query table set and a second cell in a group including cells similar to the first cell exceeds a predetermined threshold.

8. A data searching method for searching joinable source tables for a query table, the data searching method comprising:
dividing each the source table into a collection of sets, and generating, for each divided set, a group of similar cells included in the set using a similarity function for calculating cell similarity, and
searching the source table including a set in which the number of pairs of a first cell included in a divided query table set and a second cell in a group including cells similar to the first cell exceeds a predetermined threshold.

9. The data searching method according to claim 8, further comprising:
extracting a dominating relationship that is a relationship defined based on a size relationship of the number of cells included in each set group, and that indicates a relationship in which a set including a group having a large number of cells dominates a set including a same group having a small number of cells; and
selecting preferentially, as search candidates, a set that has more sets that are dominated by the dominating relationship.

10. (canceled)

11. (canceled)
